(19) United States
(12) Patent Application Publication
(10) Pub. No.: US 2011/0162051 A1
(43) Pub. Date: Jun. 30, 2011

(54) AUTHENTICATION METHODS

(76) Inventors: Yunfeng LI, Sichuan (CN); Ke CHEN, Sichuan (CN); Cheng ZHENG, Sichuan (CN)

(21) Appl. No.: 12/690,652

(22) Filed: Jan. 20, 2010

(30) Foreign Application Priority Data
Dec. 25, 2009 (CN) 200910247079.7

(51) Int. Cl. H04L 29/06; G06F 17/00

(52) U.S. Cl. 726/5

(57) ABSTRACT

A computer readable storage medium has computer-executable instructions for causing a computer system to perform a method. The method includes receiving authentication information from an electronic device; identifying the electronic device based on device information for the electronic device; locating an entry associated with a combination of the authentication information and the electronic device, the entry including a count of the number of times the authentication information failed authentication during a specified time interval; and locking out the combination if the count reaches a threshold value, thus blocking the authentication information from accessing a target.

### RELATED APPLICATION

This application claims priority to Chinese Patent Application No. 200910247079.7, entitled “Authentication Methods,” filed on Dec. 25, 2009,hereby incorporated by reference in its entirety.

### BACKGROUND

Authentication is usually required when a user attempts to log into a website through an electronic device. Typically, the user inputs authentication information (e.g., a user name and a password) via an electronic device, such as a computer or a cell phone. A server checks the user name and the password and provides a webpage to the user if the user is authenticated. However, an attacker may use software to guess the user's password to masquerade as the user. Furthermore, the website may become the target of denial-of-service (DOS) attacks.

Various methods can be used to protect the password and/or avoid a DOS attack. However, in general, those methods require more input information, which is time-consuming, and are not foolproof.

Hardware tokens and certifications (e.g., Public Key Infrastructure) can also be used to protect the password and/or avoid a DOS attack, but using these may be inconvenient to users. Another method that can be used to protect users is to count the number of unsuccessful authentication or logon attempts over a period of time; if that number reaches a threshold value, then the server locks the account. However, such an approach may make the website inaccessible to the genuine user of the account.

### SUMMARY

In one embodiment, a computer readable storage medium has computer-executable instructions for causing a computer system to perform a method. The method includes receiving authentication information from an electronic device; identifying the electronic device based on device information for the electronic device; locating an entry associated with a combination of the authentication information and the electronic device, the entry including a count of the number of times the authentication information failed authentication during a specified time interval; and locking out the combination if the count reaches a threshold value, thus blocking the authentication information from accessing a target.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a system according to one embodiment of the present invention.

FIG. 2 shows a list according to one embodiment of the present invention.

FIG. 3 shows a flowchart of an authentication method according to one embodiment of the present invention.

FIG. 4 shows a flowchart of an authentication method according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

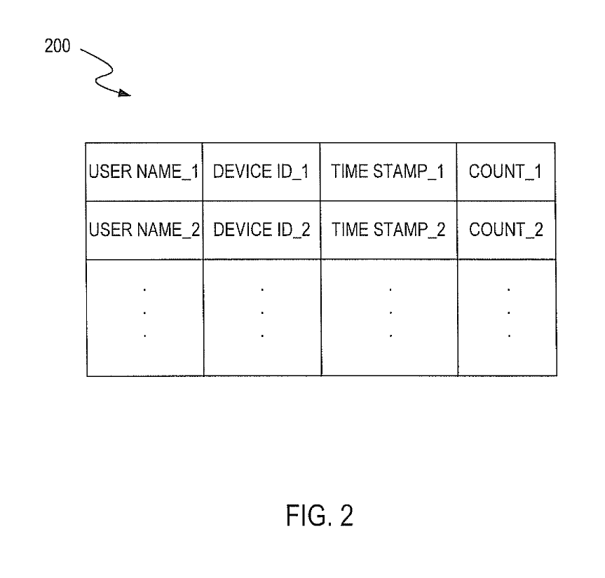

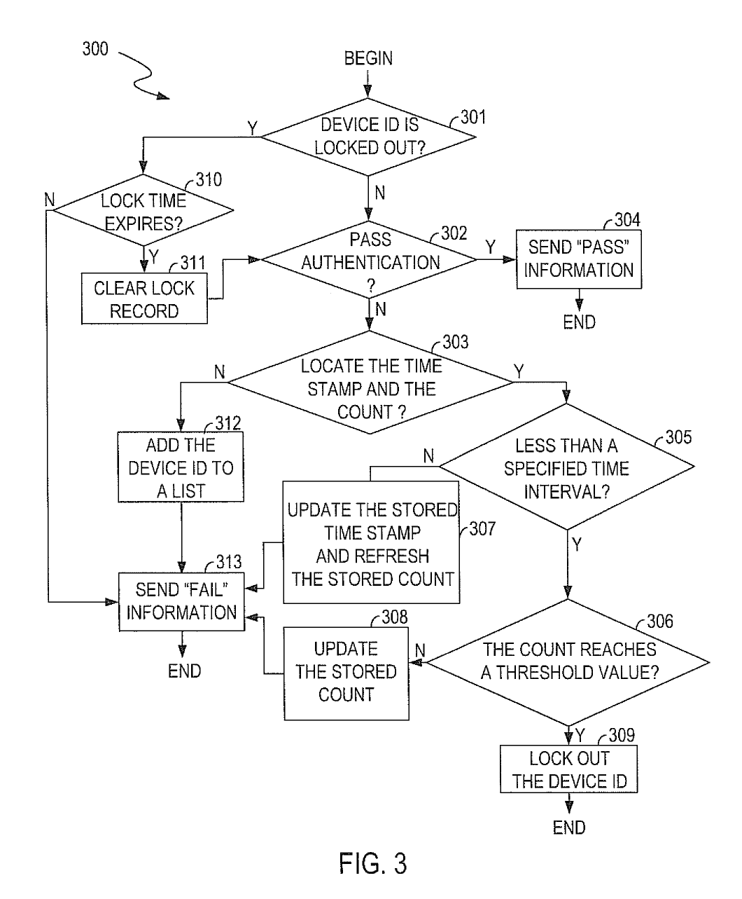

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “using,” “updating,” “locking out,” “calculating,” “accessing,” “computing,” “refreshing,” “changing,” “identifying,” “determining,” “incrementing,” “associating” or the like, refer to the actions and processes of a computer system (e.g., the processes described in conjunction with FIGS. 2 and 3), or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

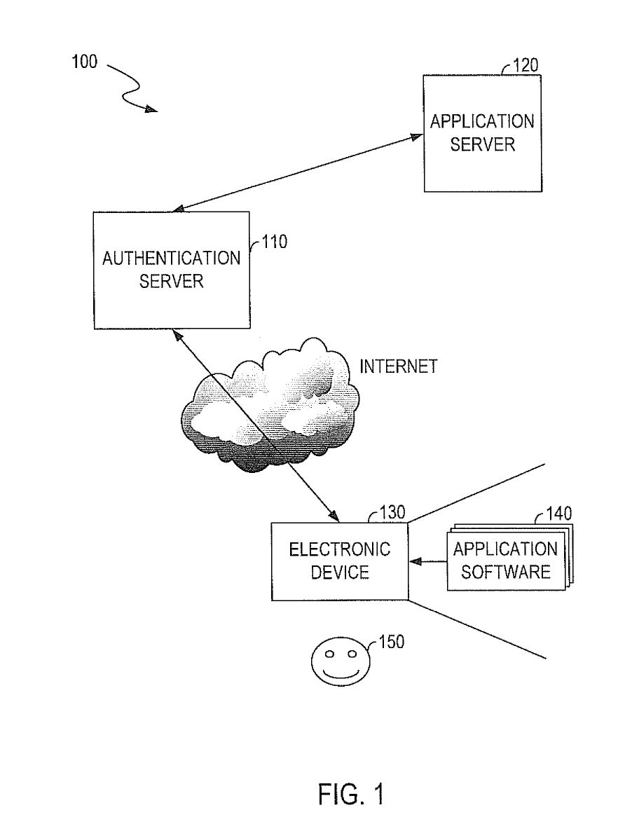

FIG. 1 shows a block diagram of a system 100 according to one embodiment of the present invention. In the example of FIG. 1, the system 100 includes an authentication server 110, an application server 120, and an electronic device 130. Application software 140 resides on the electronic device 130. The authentication server 110 is coupled to the application server 120 and to the electronic device 130 through the Internet. The authentication server 110 can authenticate a user 150 that attempts to access the application server 120 via the electronic device 130. In one embodiment, the application server 120 can be, but is not limited to, a Web server (a website residing on such a server), or an email server. In one embodiment, a data base resides on the applications server 120, or the application server 120 is coupled to a data base (not shown in FIG. 1).

A user 150 can use the application software 140 (e.g., a browser) to access the application server 120. In this instance, an access request is sent from the electronic device 130 and can be transmitted to the authentication server 110 via the Internet. In response, the authentication server 110 sends an authentication webpage to the electronic device 130 requiring that the user 150 provides authentication information (e.g., a user name and a password). The authentication information input by the user 150 can be transmitted to the authentication server 110 via the Internet.

Numbers (representing counts) and time stamps for an electronic device are stored in memory of the authentication server 110. In one embodiment, the numbers and time stamps are sorted by electronic device and authentication information; that is, for each combination of authentication information and electronic device, there is an associated number and time stamp. The number, or count, is used to indicate the number of times that the corresponding combination of authentication information and electronic device was not authenticated over a specified time interval, in one embodiment. The time stamp refers to the time that the authentication information was received by the authentication server 110. In the example of FIG. 2, time stamp_1 and count_1 correspond to user name_1 and device ID_1, and time stamp_2 and count_2 correspond to user name_2 and device ID_2.

If new authentication information sent from the same electronic device and including the same user name fails authentication, the authentication server 110 can update the associated time stamp and the associated count in the memory in the manner described below.

Advantageously, if the authentication information sent from an electronic device (e.g., the electronic device 130) in the system 100 fails the authentication, the authentication server 110 can identify the electronic device 130 and the user name included in the authentication information and locate an associated entry (count and time stamp) in the memory, in one embodiment.

The authentication server 110 can identify the electronic device 130 using device information that is unique to that device, in one embodiment. The device information can be, but is not limited to, a central processing unit (CPU) identification (ID), a hard disk (HD) ID, or a media access control (MAC) address, in one embodiment.

A component object model (COM) component can be used to access the device information for the electronic device 130. In one embodiment, the COM component can further use a hash function to calculate a device ID of the electronic device 130 based on the accessed device information. The COM component can be loaded onto the electronic device 130 by the authentication webpage as an ActiveX component. Alternatively, the COM component can be loaded by the application software 140 in the electronic device 130 as a dynamic-link library (DLL).

In one embodiment, after an access request from the electronic device 130 is transmitted to the authentication server 110, the COM component that is loaded as described above can be triggered to access the device information for the electronic device 130 and provide the device information or the calculated device ID to the authentication server 110. In one embodiment, the device information or the calculated device ID can be provided to the authentication server 110 along with the authentication information provided by the electronic device 130.

The authentication server 110 uses the authentication information and the device information or the device ID to authenticate a user in a manner such as that described below. The authentication server 110 determines whether to lock out the combination of the authentication information and the electronic device 130 for a specified period of time based on the results of the user authentication. More specifically, if a combination of a particular user name and the electronic device 130 is locked out, the authentication server 110 does not respond to any authentication information with the particular user name sent from the electronic device 130 during the specified period of time, in one embodiment.

To summarize, in one embodiment, the authentication server 110 includes a computer readable storage medium which has computer-executable instructions for causing a computer system to perform a method that includes receiving authentication information from an electronic device 130; identifying the electronic device based on device information for the electronic device 130; locating an entry associated with a combination of the authentication information and the electronic device 130, the entry including a count of the number of times the authentication information failed authentication during a specified time interval; and locking out the combination if the count reaches a threshold value, thus blocking the authentication information sent from the electronic device 130 from accessing a target (e.g., website).

Therefore, according to embodiments of the invention, a user only needs to input a user name and password for authentication, which is convenient and time-saving. Furthermore, in the event authentication fails some number of times, the account is not locked. Instead, the electronic device 130 is locked out of the account in order to protect the password and/or avoid DOS attacks. Thus, the genuine user can still access the application server 120 through other electronic devices when the electronic device 130 is locked. Furthermore, other genuine users who have different user names from the aforementioned genuine user can still access the website through the electronic device 130. Moreover, the user does not have to use hardware tokens and certifications. Thus, the authentication process is more convenient.

In another embodiment, the numbers and time stamps in the memory are sorted by electronic device; that is, for each electronic device, there is an associated number and time stamp. In this embodiment, the number, or count, is used to indicate the number of times that the authentication information from the electronic device was not authenticated over a specified time interval. If the authentication server 110 concludes a DOS attack is underway or an unauthorized user is attempting to masquerade as the genuine user, the electronic device is locked out for a specified period of time. Thus, the genuine user can still access the website through other electronic devices when the electronic device is locked.

In one embodiment, one server can perform the functions performed by the authentication server 110 and the application server 120.

FIG. 3 shows a flowchart 300 of a computer-implemented authentication method according to one embodiment of the present invention. FIG. 3 is described in combination with FIG. 1.

At 301, after authentication information sent from the electronic device 130 is received by the authentication server 110, and the device information or the device ID of the electronic device 130 is provided to the authentication server 110, the authentication server 110 checks if a lock record for a combination of the user name included in the authentication information and the electronic device 130 is in a list (shown in FIG. 2) stored in memory. In the list, combinations of user names and device information or the device ID for electronic devices that are currently locked out is stored. Thus, the authentication server 110 can determine if the combination of the user name and the electronic device 130 is locked out by determining whether that combination is included in the stored list. If the aforementioned combination is locked out, the flowchart proceeds to 310, and if not, it proceeds to 302.

At 310, the authentication server 110 determines if the lock time duration for the aforementioned combination has expired. If the lock time duration has expired, then at 311 the authentication server 110 clears the lock record for the aforementioned combination in the list and the flowchart proceeds to 302. If not, then at 313 the authentication server 110 sends “fail” information, which can be transmitted to the electronic device 130 via the Internet.

At 302, the authentication server 110 determines if the new (that is, most recent) authentication information (the information received at 301) is correct. If that information is authenticated, then at 304 the authentication server 110 sends “pass” information to the electronic device 130 via the Internet. If not, the flowchart proceeds to 303. In one embodiment, if the information is authenticated, the webpage on the application server 120 is sent to the electronic device 130 via the Internet.

At 303, the authentication server 110 uses the authentication information and the device information or the device ID for the electronic device 130 to check the stored list and determine if the list contains an entry (a number/count and time stamp) for the user name and the electronic device 130. If a number/count and a time stamp for the user name and the electronic device 130 are present in the list, then the flowchart proceeds to 305. If not, the flowchart proceeds to 312. At 312, the user name and the device information or the device ID for the electronic device 130 is added to the list in memory.

At 305, the authentication server 110 compares the time stamp stored in the list with the time stamp for the new (most recent) authentication information to determine whether both time stamps are within a specified time interval. In one embodiment, the authentication server 110 computes the difference between the time stamp associated with the new authentication information and the time stamp stored in the list. If the difference is less than a specified value, then the new authentication information and the authentication information associated with the stored time stamp were both received during the specified time interval, and the flowchart proceeds to 306. If not, the flowchart proceeds to 307.

At 306, the authentication server 110 determines if the count for the aforementioned combination has reached a threshold value. At 309, the aforementioned combination will be locked out for a period of time if the count associated with that combination has reached the threshold value. If not, the flowchart proceeds to 308.

At 307, the time stamp stored in the list is changed (updated) to the time stamp associated with the new (most recent) authentication information, the number/count stored in the list is refreshed to an initial value, and the flowchart proceeds to 313.

At 308, the number/count for aforementioned combination is updated (e.g., incremented), and the flowchart proceeds to 313.

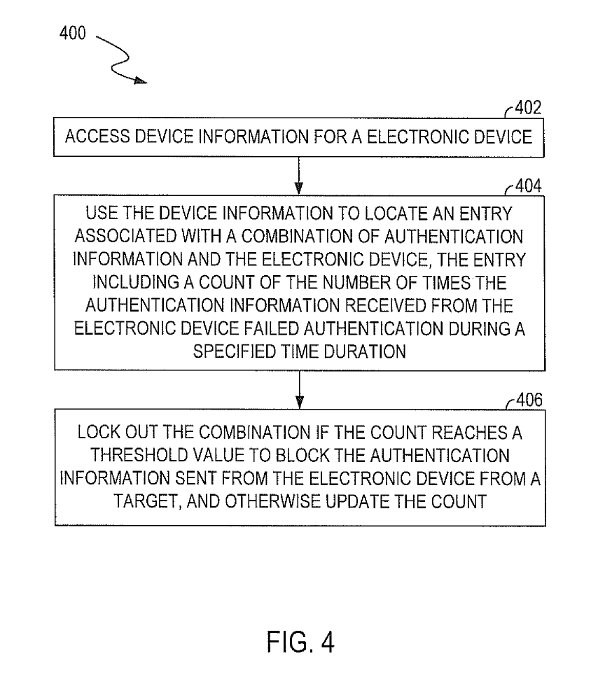

FIG. 4 shows a flowchart 400 of a computer-implemented authentication method according to one embodiment of the present invention. FIG. 4 is described in combination with FIG. 1.

At 402, device information for an electronic device 130 that fails authentication is accessed. In one embodiment, the COM component loaded in the electronic device 130 as described in FIG. 1 can be used to access the device information and provide the device information to the authentication server 110. In one embodiment, the COM component further calculates the device ID of the electronic device 130 based on the accessed device information and provides the device ID to the authentication server 110.

At 404, the device information can be used to locate an entry (e.g., a count and a time stamp) associated with a combination of authentication information and the electronic device 130 in a list in the memory of the authentication server 110. In one embodiment, the counts and the time stamps in the list are sorted (indexed) by the device information and the user name as described above. The number or count is used to indicate the number of times that authentication information with that user name was received from the electronic device 130 and failed to be authenticated over a specified time interval.

At 406, the combination of the authentication information and the electronic device 130 is locked out for a period of time if the aforementioned count reaches a threshold value. In one embodiment, the authentication server 110 firstly determines if the new (most recent) authentication information and the authentication information associated with the stored time stamp are received within a specified time interval. If so, the authentication server 110 determines if the count has reached the threshold value. If the count associated with the aforementioned combination reaches the threshold value, that combination is locked out for a specified period of time. In this instance, the authentication server may not respond to any authentication information with that user name sent from the electronic device 130 during that time period. If the count associated with the aforementioned combination has not reached the threshold value, the count can be updated (incremented). In another embodiment, the authentication server 110 firstly determines if the new (most recent) authentication information and the authentication information associated with the stored time stamp are received within a specified time interval. If so, the count associated with the aforementioned combination can be updated (incremented). Then, the authentication server 110 determines if the updated count has reached the threshold value. If the count has reached the threshold value, the aforementioned combination; that is, the user name and the electronic device 130 are locked out for a period of time. The stored time stamp can be updated to the time stamp associated with the new authentication information, and the count can be refreshed to an initial value if the new authentication information and the authentication information associated with the stored time stamp are not received within the specified time interval.

To summarize, there are disadvantages in conventional methods for protecting a password and/or avoiding a DOS attack. In contrast, embodiments of the present invention provide methods and systems that save time and are more secure. The device information for an electronic device which sends an access request to an authentication server can be accessed, and the device information can be used to locate a number (count) and a time stamp stored by the authentication server. The stored number and time stamp can be used to determine if a DOS attack is underway or if an unauthorized user is attempting to masquerade as the genuine user, in which case the electronic device is locked out for a period of time. Therefore, secure information can be protected and DOS attacks can be avoided. Furthermore, the genuine user can continue to access the website using another electronic device and other users who have different user names from the aforementioned genuine user can still access the website through the aforementioned electronic device.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A computer readable storage medium having computer-executable instructions for causing a computer system to perform a method comprising:
receiving authentication information from an electronic device;
identifying said electronic device based on device information for said electronic device;
locating an entry associated with a combination of said authentication information and said electronic device, said entry comprising a count of the number of times said authentication information failed authentication during a specified time interval; and
locking out said combination if said count reaches a threshold value to block said authentication information from accessing a target.

2. The storage medium of claim 1, wherein said authentication information comprises a user name and a password.

3. The storage medium of claim 2, wherein said count is associated with said electronic device and said user name.

4. The storage medium of claim 1, wherein said device information is selected from the group consisting of a CPU (central processing unit) ID (identification), HD (hard disk) ID and MAC (Media Access Control) address.

5. The storage medium of claim 1, wherein a device identification (ID) for said electronic device is calculated based on said device information, wherein said device ID is used to identify said electronic device.

6. The storage medium of claim 1, wherein a component object model (COM) component is loaded onto said electronic device by said target and is used to access said device information and provide said device information for identifying said electronic device.

7. The storage medium of claim 1, wherein a component object model (COM) component is loaded by application software in said electronic device and is used to access said device information and provide said device information to said server for identifying said electronic device.

8. The storage medium of claim 1, wherein said count is updated if a difference between a time stamp associated with first authentication information and a time stamp associated with second authentication information is less than said specified time interval.

9. The storage medium of claim 8, wherein said time stamp associated with said first authentication information is changed to the later of said time stamp associated with said first authentication information and said time stamp associated with said second authentication information if said difference is larger than said specified time interval.

10. The storage medium of claim 1, wherein said count is refreshed to an initializing value if a difference between a time stamp associated with first authentication information and a time stamp associated with second authentication information is larger than said specified time interval.

11. The storage medium of claim 10, wherein said time stamp associated with said first authentication information is changed to the later of said time stamp associated with said first authentication information and said time stamp associated with said second authentication information if said difference is larger than said specified time interval.

12. A computer-implemented authentication method, comprising:
accessing device information for an electronic device;
using said device information to locate an entry associated with a combination of authentication information and said electronic device, said entry comprising a count of the number of times said authentication information failed authentication during a specified time interval; and
locking out said combination if said count reaches a threshold value to block said authentication information from accessing a target, and otherwise updating said count.

13. The method of claim 12, further comprising:
calculating a device identification (ID) for said electronic device based on said device information; and
using said device ID to locate said entry.

14. The method of claim 12, wherein said updating comprises:
accessing a time stamp associated with first authentication information and a time stamp associated with second authentication information;
computing a difference between said time stamp associated with said first authentication information and said time stamp associated with said second authentication information; and
refreshing said count to an initial value if said difference is larger than said specified time interval and otherwise incrementing said count.

15. The method of claim 14, further comprising:
changing said time stamp associated with said first authentication information to said time stamp associated with said second authentication information if said difference is larger than said specified time interval.

16. The method of claim 12, wherein said device information is selected from the group consisting of a CPU (central processing unit) ID (identification), HD (hard disk) ID and MAC (Media Access Control) address.

17. A computer-implemented authentication method, comprising:
identifying first authentication information and second authentication information received from the same electronic device, wherein device information for said electronic device is used in said identifying;
determining whether said first and second authentication information are received during a specified time interval;
incrementing a count associated with said electronic device if both said first and second authentication information are received in said specified time interval and if both said first and second authentication information fail authentication, and otherwise refreshing said count to an initial value associated with said electronic device; and
locking out said electronic device if a value of said count exceeds a first threshold to block said electronic device from accessing a target.

18. The method of claim 17, wherein said determining comprises:
computing a difference between a time stamp associated with said first authentication information and a time stamp associated with said second authentication information, wherein said first and second authentication information are received during said specified time interval if said difference is less than said specified time interval.

19. The method of claim 18, further comprising:
associating the later of said time stamp associated with said first authentication information and said time stamp associated with said second authentication information with said count if said difference is larger than said specified time interval.

20. The method of claim 17, wherein said device information is selected from the group consisting of a CPU (central processing unit) ID (identification), HD (hard disk) ID and MAC (Media Access Control) address.
